(19) United States
(12) Patent Application Publication
(10) Pub. No.: US 2023/0137429 A1
(43) Pub. Date: May 4, 2023

(54) DRIVE APPARATUS

(71) Applicant: NIDEC CORPORATION, Kyoto (JP)

(72) Inventors: Keisuke NAKATA, Kyoto (JP); Yuki ISHIKAWA, Kyoto (JP); Sota DOI, Kyoto (JP); Kouhei OBA, Kyoto (JP)

(21) Appl. No.: 17/974,525

(22) Filed: Oct. 27, 2022

(30) Foreign Application Priority Data
Oct. 29, 2021 (JP) 2021-178105

(51) Int. Cl. H02K 5/20; H02K 9/193; H02K 7/116

(52) U.S. Cl. CPC H02K 5/203; H02K 9/193; H02K 7/116; H02K 2205/09

(57) ABSTRACT

One aspect of a drive apparatus of the present invention includes a motor having a rotor that rotates about a motor axis and a stator that surrounds the rotor, a housing having a motor accommodating portion that accommodates the motor, a fluid stored in the housing, a flow path through which the fluid flows, and a pump that pressure-feeds the fluid in the flow path. The flow path includes a pipe-shaped intra-housing flow path that is disposed inside the motor accommodating portion and is provided with a feed hole for feeding the fluid to the motor, a pipe portion that is disposed inside the motor accommodating portion and relays between the pump and the intra-housing flow path, and an intra-side wall flow path that is provided in a wall portion of the housing and connects the pipe portion and the intra-housing flow path. The pipe portion and the intra-housing flow path are connected to each other by a coupling portion.

### CROSS-REFERENCE TO RELATED APPLICATIONS

The present invention claims priority under 35 U.S.C. § 119 to Japanese Patent Application No. 2021-178105 filed on Oct. 29, 2021, the entire content of which is incorporated herein by reference.

### FIELD OF THE INVENTION

The present invention relates to a drive apparatus.

### BACKGROUND

In recent years, the development of drive apparatuses to be mounted on electric vehicles has been actively carried out. Such a drive apparatus is equipped with a cooling structure for cooling a stator of a rotating electrical machine. For example, there is a conventional structure in which a fluid cooled by a cooler and pressure-fed by a pump is fed into and out of a motor.

In the conventional structure, a flow path for circulating cooling water via a cooler and a pump is disposed outside a housing. Therefore, it is necessary to provide a pipe outside the housing, and there is a problem that the drive apparatus tends to be enlarged.

### SUMMARY

One aspect of an exemplary drive apparatus of the present invention includes a motor having a rotor that rotates about a motor axis and a stator that surrounds the rotor, a housing having a motor accommodating portion that accommodates the motor, a fluid stored in the housing, a flow path through which the fluid flows, and a pump that pressure-feeds the fluid in the flow path. The flow path includes a pipe-shaped intra-housing flow path that is disposed inside the motor accommodating portion and is provided with a feed hole for feeding the fluid to the motor, a pipe portion that is disposed inside the motor accommodating portion and relays between the pump and the intra-housing flow path, and an intra-side wall flow path that is provided in a wall portion of the housing and connects the pipe portion and the intra-housing flow path. The pipe portion and the intra-housing flow path are connected to each other by a coupling portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual view of a drive apparatus of an embodiment;

FIG. 2 is a perspective view of a bearing and a bearing holder disposed around an output axis J3 in the drive apparatus according to an embodiment;

FIG. 3 is a front view of a gear cover according to an embodiment;

FIG. 4 is a cross-sectional view of the drive apparatus according to an embodiment;

FIG. 5 is a partial cross-sectional view of a drive apparatus according to a modification;

FIG. 6 is a front view of the housing body according to the embodiment when viewed from a gear accommodating portion side;

FIG. 7 is a cross-sectional view of the housing body taken along line VII-VII of FIG. 6;

FIG. 8 is a perspective view of a flow path member of an embodiment;

FIG. 9 is a schematic view of a flow path member of a modification;

FIG. 10 is a schematic cross-sectional view of a drive apparatus 101 of Modification 1; and

FIG. 11 is a schematic cross-sectional view of a drive apparatus 201 according to Modification 2.

### DETAILED DESCRIPTION

The description below will be made with the direction of gravity being specified based on a positional relationship in a case where the drive apparatus 1 is mounted in a vehicle located on a horizontal road surface. In the drawings, an XYZ coordinate system is shown appropriately as a three-dimensional orthogonal coordinate system.

In the XYZ coordinate system, a Z-axis direction corresponds to a vertical direction (i.e., an up-down direction), and a +Z direction points upward (i.e., in a direction opposite to the direction of gravity), while a −Z direction points downward (i.e., in the direction of gravity).

The X-axis direction is a direction orthogonal to the Z-axis direction and indicates the front-rear direction of the vehicle on which the drive apparatus 1 is mounted. The −X direction is the front of the vehicle (one side in the front-rear direction), and the +X direction is the rear of the vehicle (the other side in the front-rear direction). Note, however, that the +X direction and the −X direction may point forward and rearward, respectively, of the vehicle. A Y-axis direction is a direction orthogonal to both the X-axis direction and the Z-axis direction, and is a width direction (right-left direction) of the vehicle.

In the description below, unless otherwise specified, a direction (i.e., the Y-axis direction) parallel to a motor axis J1 will be simply referred to by the term “axial direction”, “axial”, or “axially”, radial directions around the motor axis J1 will be simply referred to by the term “radial direction”, “radial”, or “radially”, and a circumferential direction around the motor axis J1, i.e., a circumferential direction about the motor axis J1, will be simply referred to by the term “circumferential direction”, “circumferential”, or “circumferentially”. Note, however, that the term “parallel” as used above includes both “parallel” and “substantially parallel”.

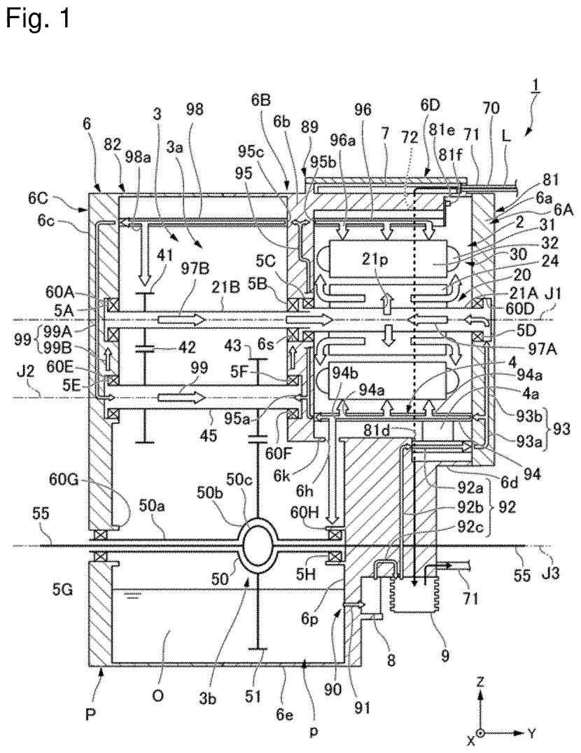

FIG. 1 is a conceptual view of a drive apparatus 1 of the present embodiment. Note that the relative positional relationship in the up-down direction (Z-axis direction) of each part in FIG. 1 may be different from the actual positional relationship along with the schematic illustration. In particular, in FIG. 1, an intermediate axis J2 and an output axis J3 are illustrated with their positions reversed from each other in the up-down direction.

The drive apparatus 1 according to the present embodiment is mounted in a vehicle having a motor as a power source, such as a hybrid vehicle (HEV), a plug-in hybrid vehicle (PHV), and an electric vehicle (EV), and is used as a power source of the vehicle.

The drive apparatus 1 includes a motor 2, a transmission mechanism 3, an inverter 7, a housing 6, a fluid O stored in the housing 6, a pump 8, a cooler 9, a plurality of bearings 5A, 5B, 5C, 5D, 5E, 5F, 5G, and 5H, a flow path 90, a refrigerant L, and a refrigerant flow path 70.

The housing 6 includes a motor accommodating portion 81 that accommodates the motor 2, a gear accommodating portion 82 that accommodates the transmission mechanism 3, and an inverter accommodating portion 89 that accommodates the inverter 7. The gear accommodating portion 82 is located on the other side (−Y side) in the axial direction of the motor accommodating portion 81. The inverter accommodating portion 89 is located above the motor accommodating portion 81.

The motor 2 of the present embodiment is an inner rotor type three-phase AC motor. The motor 2 has both a function as an electric motor and a function as a generator.

The motor 2 includes a rotor 20 arranged to rotate about the motor axis J1, which extends in a horizontal direction, and a stator 30 arranged radially outside of the rotor 20. The motor 2 of the present embodiment is an inner rotor type motor in which the rotor 20 is disposed inside the stator 30.

The stator 30 encloses the rotor 20 from radially outside. The stator 30 has a stator core 32, a coil 31, and an insulator (not illustrated) interposed between the stator core 32 and the coil 31. The stator 30 is held by the housing 6.

The rotor 20 rotates about the motor axis J1 extending in the horizontal direction. The rotor 20 includes a motor shaft 21A, a rotor core 24 fixed to an outer peripheral surface of the motor shaft 21A, and a rotor magnet (not illustrated) fixed to the rotor core. The torque of the rotor 20 is transferred to the transmission mechanism 3.

The motor shaft 21A extends along the axial direction about the motor axis J1. The motor shaft 21A rotates about the motor axis J1. The motor shaft 21A is a shaft having a hollow portion extending in the axial direction. The motor shaft 21A is rotatably supported by the housing 6 via bearings 5C and 5D.

The stator 30 is held by the housing 6. The stator 30 encloses the rotor 20 from radially outside. The stator 30 includes the annular stator core 32 centered on the motor axis J1, the coil 31 mounted on the stator core 32, and an insulator (not illustrated) interposed between the stator core 32 and the coil 31. The stator core 32 has a plurality of magnetic pole teeth (not illustrated) radially inward from an inner peripheral surface of an annular yoke. A coil wire is disposed between the magnetic pole teeth. The coil wire located in the gap between the adjacent magnetic pole teeth constitutes the coil 31. The insulator is made of an insulating material.

The transmission mechanism 3 transmits power of the motor 2 and outputs the power to an output shaft 55. The transmission mechanism 3 includes a reduction gear 3a and a differential device 3b. The torque output from the motor 2 is transmitted to the differential device 3b via the reduction gear 3a. The reduction gear 3a is a speed reducer of a parallel-axis gearing type, in which center axes of gears are disposed in parallel with each other. The differential device 3b transmits the same torque to the left and right wheels while absorbing the speed difference between the left and right wheels when the vehicle turns.

The transmission mechanism 3 includes a first shaft (shaft) 21B, a second shaft (shaft) 45, a first gear 41, a second gear 42, and a third gear 43. The differential device 3b includes a ring gear 51, a differential case 50, and a differential mechanism 50c disposed inside the differential case 50. That is, the transmission mechanism 3 includes the first shaft 21B, the second shaft 45, the plurality of gears 41, 42, 43, and 51, the differential case 50, and the differential mechanism 50c.

The first shaft 21B extends in the axial direction about the motor axis J1. The first shaft 21B is disposed coaxially with the motor shaft 21A. The first shaft 21B is coupled to the end portion on the other side (−Y side) in the axial direction of the motor shaft 21A in the end portion on one side (+Y side) in the axial direction. As a result, the first shaft 21B is coupled to the rotor 20 from the other side in the axial direction.

The outer diameter of the end portion on one side (+Y side) in the axial direction of the first shaft 21B is smaller than the inner diameter of the end portion on the other side (−Y side) in the axial direction of the motor shaft 21A. Splines meshing with each other are provided on an outer peripheral surface of an end portion on one side (+Y side) in the axial direction of the first shaft 21B and an inner peripheral surface of an end portion on the other side (−Y side) in the axial direction of the motor shaft 21A.

In the present embodiment, the case where the shafts are coupled by inserting the end portion of the first shaft 21B into the hollow portion of the end portion of the motor shaft 21A has been described. However, a configuration in which the end portion of the motor shaft 21A is inserted into the hollow portion of the end portion of the first shaft 21B to be coupled may be adopted. In this case, splines that mesh with each other are provided on the outer peripheral surface of the end portion of the motor shaft 21A and the inner peripheral surface of the end portion of the first shaft 21B.

The first shaft 21B rotates around the motor axis J1 together with the motor shaft 21A. The first shaft 21B is a hollow shaft having a hollow portion therein. The first shaft 21B is rotatably supported by the housing 6 via the bearings 5A and 5B.

The first gear 41 is provided on the outer peripheral surface of the first shaft 21B. The first gear 41 rotates about the motor axis J1 together with the first shaft 21B. The second shaft 45 rotates about the intermediate axis J2 parallel to the motor axis J1. The second gear 42 and the third gear 43 are disposed side by side in the axial direction. The second gear 42 and the third gear 43 are provided on the outer peripheral surface of the second shaft 45. The second gear 42 and the third gear 43 are connected via the second shaft 45. The second gear 42 and the third gear 43 rotate about the intermediate axis J2. The second gear 42 meshes with the first gear 41. The third gear 43 meshes with the ring gear 51 of the differential device 3b.

The ring gear 51 rotates about the output axis J3 parallel to the motor axis J1. The torque outputted from the motor 2 is transferred to the ring gear 51 through the reduction gear 3a. The ring gear 51 is fixed to the differential case 50.

The differential case 50 includes a case portion 50b that accommodates the differential mechanism 50c therein, and a differential case shaft (shaft) 50a that protrudes to one side and the other side in the axial direction with respect to the case portion 50b. That is, the transmission mechanism 3 includes the differential case shaft 50a. The differential case shaft 50a has a tubular shape extending along the axial direction around the output axis J3. The ring gear 51 is provided on the outer peripheral surface of the differential case shaft 50a. The differential case shaft 50a rotates together with the ring gear 51 about the output axis J3.

The pair of output shafts 55 is connected to the differential device 3b. The pair of output shafts 55 protrudes from the differential case 50 of the differential device 3b to one side and the other side in the axial direction. The output shaft 55 is disposed inside the differential case shaft 50a. The output shaft 55 is rotatably supported on the inner peripheral surface of the differential case shaft 50a via a bearing (not illustrated).

The torque output from the motor 2 is transmitted to the ring gear 51 of the differential device 3b via the first shaft 21B, the first gear 41, the second gear 42, the second shaft 45, and the third gear 43 of the transmission mechanism 3, and is output to the output shaft 55 via the differential mechanism 50c of the differential device 3b. The plurality of gears (41, 42, 43, 51) of the transmission mechanism 3 transmits power of the motor 2 through the first shaft 21B, the second shaft 45, and the differential case shaft 50a in this order.

The housing 6 includes a housing body 6B, a motor cover 6A, a gear cover 6C, and an inverter cover 6D. The housing body 6B, the motor cover 6A, the gear cover 6C, and the inverter cover 6D are separate members. The motor cover 6A is disposed on one side (+Y side) in the axial direction of the housing body 6B. The gear cover 6C is disposed on the other side (−Y side) in the axial direction of the housing body 6B. The inverter cover 6D is disposed on the upper side of the housing body 6B.

The housing 6 includes the motor accommodating portion 81, the gear accommodating portion 82, and the inverter accommodating portion 89. The motor accommodating portion 81, the gear accommodating portion 82, and the inverter accommodating portion 89 are configured by respective portions of the housing body 6B, the motor cover 6A, the gear cover 6C, and the inverter cover 6D.

The motor accommodating portion 81 includes a cylindrical portion of the housing body 6B and the motor cover 6A that covers an opening on one side (+Y side) in the axial direction of the cylindrical portion. The motor 2 is disposed in a space surrounded by the housing body 6B and the motor cover 6A.

The gear accommodating portion 82 includes a recessed portion that opens to the other side (−Y side) in the axial direction of the housing body 6B and the gear cover 6C that covers the opening of the recessed portion. The transmission mechanism 3 is disposed in a space surrounded by the housing body 6B and the gear cover.

The inverter accommodating portion 89 includes a box-shaped portion opened to the upper side of the housing body 6B and the inverter cover 6D covering the opening of the box-shaped portion. The inverter 7 is disposed in a space surrounded by the housing body 6B and the inverter cover 6D.

The housing 6 includes a first side wall portion 6a, a second side wall portion (side wall portion) 6b, and a third side wall portion 6c which extend along a plane orthogonal to the motor axis J1, a motor peripheral wall portion 6d surrounding the motor 2 from radially outside, and a gear peripheral wall portion 6e surrounding the transmission mechanism 3 from radially outside.

The first side wall portion 6a is provided on the motor cover 6A. The first side wall portion 6a constitutes a part of the motor accommodating portion 81. The first side wall portion 6a is located on one side (+Y side) in the axial direction of the motor 2.

The second side wall portion 6b is provided in the housing body 6B. The second side wall portion 6b is located on the other side (−Y side) in the axial direction of the motor 2. The second side wall portion 6b defines an internal space of the motor accommodating portion 81 and an internal space of the gear accommodating portion 82. The second side wall portion 6b constitutes a part of the motor accommodating portion 81 and the gear accommodating portion 82.

The second side wall portion 6b has a vertical wall region 6k extending along the axial direction. The vertical wall region 6k faces the radial inside of the output axis J3. The second side wall portion 6b is configured in a stepped shape in which a region close to the output axis J3 is disposed on one side in the axial direction with respect to a region far from the vertical wall region 6k as a boundary. The vertical wall region 6k expands the internal space of the gear accommodating portion 82 around the output axis J3 to one side (+Y side) in the axial direction. Since the vertical wall region 6k is provided in the second side wall portion 6b, a space in which the differential device 3b is disposed in the gear accommodating portion 82 can be secured to be wider in the axial direction than other regions.

The second side wall portion 6b is provided with a shaft passing hole 6s and a through hole 6h. The shaft passing hole 6s allows the internal spaces of the motor accommodating portion 81 and the gear accommodating portion 82 to communicate with each other. In the shaft passing hole 6s, the bearing 5C supporting the motor shaft 21A and the bearing 5B supporting the first shaft 21B are disposed. The motor shaft 21A and the first shaft 21B are coupled to each other inside the shaft passing hole 6s.

The through hole 6h is provided in the vertical wall region 6k of the second side wall portion 6b. Therefore, the through hole 6h penetrates the second side wall portion 6b in the radial direction of the output axis J3. The through hole 6h allows the internal space of the motor accommodating portion 81 and the internal space of the gear accommodating portion 82 to communicate with each other.

The third side wall portion 6c is provided on the gear cover 6C. The third side wall portion 6c constitutes a part of the gear accommodating portion 82. The third side wall portion 6c is disposed on the other side (−Y side) in the axial direction of the transmission mechanism 3.

The motor peripheral wall portion 6d is provided in the housing body 6B. The motor peripheral wall portion 6d constitutes a part of the motor accommodating portion 81. The motor peripheral wall portion 6d has a tubular shape extending along the axial direction around the motor axis J1. The motor peripheral wall portion 6d connects the second side wall portion 6b and the first side wall portion 6a. The motor peripheral wall portion 6d surrounds the outer periphery of the motor 2 from the radial outside of the motor axis J1.

The gear peripheral wall portion 6e is configured by a part of the housing body 6B and a part of the gear cover 6C. The gear peripheral wall portion 6e constitutes a part of the gear accommodating portion 82. The gear peripheral wall portion 6e extends along the axial direction. The gear peripheral wall portion 6e connects the third side wall portion 6c and the second side wall portion 6b. The gear peripheral wall portion 6e surrounds the gears 41, 42, 43, and 51 from the radial outside of the motor axis J1, the intermediate axis J2, and the output axis J3.

The plurality of bearings 5A, 5B, 5C, 5D, 5E, 5F, 5G, and 5H are held by the housing 6, and rotatably support any one of the motor shaft 21A, the first shaft 21B, the second shaft 45, and the differential case shaft 50a.

The motor shaft 21A is supported by the bearings 5C and 5D. The bearing 5C is disposed inside the shaft passing hole 6s provided in the second side wall portion 6b and is held by the second side wall portion 6b. The bearing 5D is held by the first side wall portion 6a. The first side wall portion 6a is provided with a bearing holder 60D that holds the bearing 5D.

The first shaft 21B is supported by the bearings 5A and 5B. The bearing (second bearing) 5A is held by the third side wall portion 6c. The third side wall portion 6c is provided with a bearing holder (second bearing holder) 60A that holds the bearing 5A. That is, the bearing holder 60A supports the shaft (first shaft 21B) of the transmission mechanism 3 via the bearing 5A. The bearing 5B is disposed inside the shaft passing hole 6s provided in the second side wall portion 6b and is held by the second side wall portion 6b.

The second shaft 45 is supported by the bearings 5E and 5F. The bearing 5E is held by the third side wall portion 6c. The third side wall portion 6c is provided with a bearing holder 60E that holds the bearing 5E. The bearing (first bearing) 5F is held by the second side wall portion 6b. The second side wall portion 6b is provided with a bearing holder (first bearing holder) 60F that holds the bearing 5F. That is, the bearing holder 60F supports the shaft (second shaft 45) of the transmission mechanism 3 via the bearing 5F.

The differential case shaft 50a is supported by the bearings 5G and 5H. The bearing 5G is held by the third side wall portion 6c. The third side wall portion 6c is provided with a bearing holder 60G that holds the bearing 5G. The bearing 5H is held by the second side wall portion 6b. The second side wall portion 6b is provided with a bearing holder 60H that holds the bearing 5H. The bearing holder 60H is provided on a first gear facing surface (gear facing surface) 6p facing the transmission mechanism 3 of the second side wall portion 6b. The bearing holder 60H supports the differential case shaft 50a via the bearing 5H.

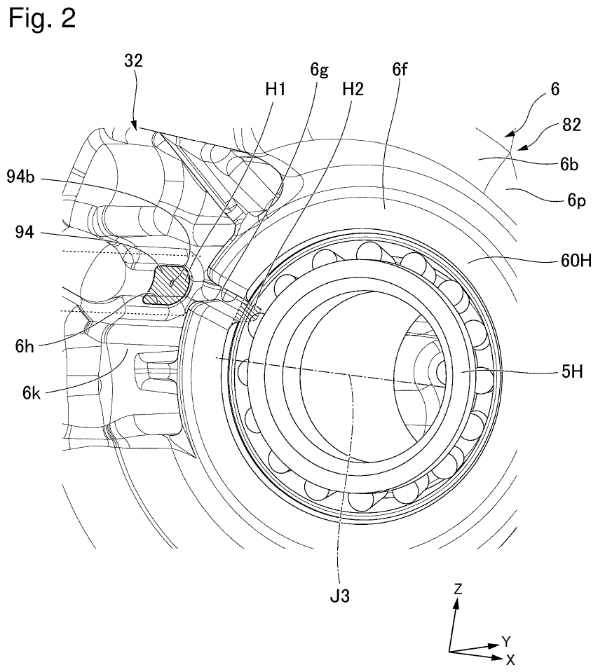

FIG. 2 is a perspective view of the bearing 5H and the bearing holder 60H.

As illustrated in FIG. 2, the bearing holder 60H has a cylindrical portion 6f surrounding the bearing 5H. The cylindrical portion 6f has a cylindrical shape centered on the output axis J3. The cylindrical portion 6f protrudes in the axial direction from a surface facing the other side (−Y side) in the axial direction of the second side wall portion 6b.

The cylindrical portion 6f is provided with a notch (opening) 6g extending in the axial direction from the tip. Therefore, the bearing 5H is exposed radially outward of the output axis J3 in the notch 6g. The notch 6g is provided in a portion of the cylindrical portion 6f disposed on the vehicle front side (−X side, one side in front-rear direction) with respect to the output axis J3. A portion of the cylindrical portion 6f where the notch 6g is provided faces the vertical wall region 6k of the second side wall portion 6b. As described above, the through hole (opening) 6h is provided in the vertical wall region 6k. The notch 6g and the through hole 6h are disposed side by side in the radial direction of the output axis J3.

The fluid O accumulates in the housing 6. The fluid O circulates in the flow path 90 described later. In the present embodiment, the fluid O is oil. The fluid O is used not only for cooling the motor 2 but also for lubricating the transmission mechanism 3. An oil equivalent to an automatic transmission fluid (ATF) having a relatively low viscosity is preferably used as the fluid O so that the oil can perform functions of a lubricating oil and a cooling oil.

A fluid reservoir P in which the fluid O is stored is provided in a lower region in the housing 6. In the present embodiment, the fluid reservoir is provided in the gear accommodating portion 82. The fluid O accumulated in the fluid reservoir P is scraped up by the operation of the transmission mechanism 3 and diffused into the gear accommodating portion 82.

The fluid O diffused in the gear accommodating portion 82 is fed to each gear of the transmission mechanism 3 in the gear accommodating portion 82 to spread the fluid O over the tooth surfaces of the gears. The fluid O fed to the transmission mechanism 3 and used for lubrication drops and is collected in the fluid reservoir P in the gear accommodating portion 82.

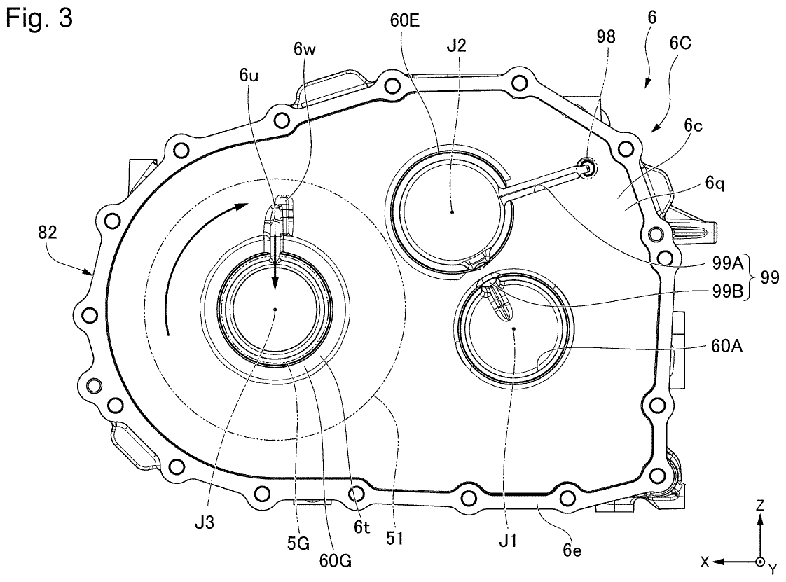

FIG. 3 is a front view of the gear cover 6C.

As illustrated in FIG. 3, the third side wall portion 6c of the housing 6 is provided with a second gear facing surface 6q facing the transmission mechanism 3. The bearing holder 60G is provided on the second gear facing surface 6q. The bearing holder 60G has a cylindrical portion 6t centered on the output axis J3.

The second gear facing surface 6q is provided with a guide rib 6w disposed directly above the cylindrical portion 6t of the bearing holder 60G and a guide groove portion 6u extending along the guide rib 6w. The guide rib 6w protrudes from the second gear facing surface 6q on one side (+Y side) in the axial direction. The guide rib 6w extends along the up-down direction. The lower end portion of the guide rib 6w is connected to the outer peripheral surface of the cylindrical portion 6t. The guide groove portion 6u is disposed on the other side (+X side, vehicle rear side) in the front-rear direction of the guide rib 6w. The guide groove portion 6u penetrates the inside and outside of the cylindrical portion 6t.

The ring gear 51 rotating around the output axis J3 scrapes up the fluid O accumulated inside the gear accommodating portion 82. When the vehicle travels forward (−X side), the ring gear 51 scoops up the fluid O on the vehicle rear side (+X side) with respect to the ring gear 51. The fluid O scraped up by the ring gear 51 scatters to the upper side of the ring gear 51 and hits a surface of the guide rib 6w facing the vehicle rear side (+X side). The fluid O that has hit the guide rib 6w flows into the guide groove portion 6u, flows along the inner surface of the guide groove portion 6u, and is guided to the inside of the bearing holder 60G. As a result, the fluid O lubricates the bearing 5G.

The flow path 90 illustrated in FIG. 1 is provided in the housing 6. The flow path 90 is a circulation path through which the fluid O flows. That is, the fluid O flows through the flow path 90 provided in the housing 6. The flow path 90 is a path of the fluid O that is fed to the fluid O from the fluid reservoir P to the motor 2 and the transmission mechanism 3.

The flow path 90 is provided with the pump 8 and the cooler 9. The pump 8 and the cooler 9 are each fixed to the outer side face of the housing 6.

The pump 8 pressure-feeds the fluid O in the flow path 90. The pump 8 is an electric pump driven by electricity. The pump 8 may be a mechanical pump that operates in accordance with the drive of the transmission mechanism 3. When the pump 8 is a mechanical pump, the pump 8 is coupled to the output shaft 55 or the differential case shaft 50a via a gear or the like, and is driven by power of the transmission mechanism 3.

The cooler 9 cools the fluid O in the flow path 90. An internal flow path (not illustrated) through which the fluid O flows and an internal refrigerant flow path (not illustrated) through which the refrigerant L flows are provided inside the cooler 9. The cooler 9 is a heat exchanger that cools the fluid O by transferring heat of the fluid O to the refrigerant L.

The flow path 90 of the present embodiment includes a suction flow path 91, a discharge flow path 92, a first intra-side wall flow path 93, a first intra-housing flow path (intra-housing flow path) 94, a second intra-side wall flow path 95, a second intra-housing flow path 96, a first intra-shaft flow path 97A, a third intra-housing flow path 98, a third intra-side wall flow path 99, and a second intra-shaft flow path 97B.

The suction flow path 91, a part of the discharge flow path 92, the first intra-side wall flow path 93, the second intra-side wall flow path 95, and the third intra-side wall flow path 99 are holes provided in the housing 6. The suction flow path 91, a part of the discharge flow path 92, the first intra-side wall flow path 93, the second intra-side wall flow path 95, and the third intra-side wall flow path 99 are formed by drilling a wall portion of the housing 6.

A part of the discharge flow path 92, the first intra-housing flow path 94, the second intra-housing flow path 96, and the third intra-housing flow path 98 are pipe members disposed in the housing 6. A part of the discharge flow path 92, the first intra-housing flow path 94, and the second intra-housing flow path 96 are disposed inside the motor accommodating portion 81. On the other hand, the third intra-housing flow path 98 is disposed inside the gear accommodating portion 82.

The first intra-shaft flow path 97A and the second intra-shaft flow path 97B are provided in hollow portions of the motor shaft 21A and the first shaft 21B, respectively. The hollow portion of the motor shaft 21A and the hollow portion of the first shaft 21B are coupled to each other. Therefore, the fluid O in the first intra-shaft flow path 97A and the fluid O in the second intra-shaft flow path 97B merge inside the motor shaft 21A or the first shaft 21B.

The suction flow path 91 connects the fluid reservoir P of the housing 6 and the pump 8. The end portion of the suction flow path 91 on the upstream side opens to the fluid reservoir P. The suction flow path 91 penetrates the inside of the wall of the gear accommodating portion 82. The suction flow path 91 guides the fluid O in the fluid reservoir P to the pump 8.

The discharge flow path 92 connects the pump 8 and the first intra-side wall flow path 93. The cooler 9 is disposed in the path of the discharge flow path 92. The discharge flow path 92 has a pipe portion 92a, a first hole (hole) 92b, and a second hole (hole) 92c. The pipe portion 92a has a pipe shape disposed in the internal space of the motor accommodating portion 81. On the other hand, the first hole 92b and the second hole 92c are provided in the wall portion of the housing 6 by drilling. The fluid O flows through the discharge flow path 92 in the order of the second hole 92c, the first hole 92b, and the pipe portion 92a.

The second hole 92c connects the discharge port of the pump 8 and the inflow port of the cooler 9. The second hole 92c feeds the fluid O from the pump 8 to the cooler 9. The first hole 92b connects the outflow port of the cooler 9 and the internal space of the motor accommodating portion 81. A stepped surface 81d facing one axial side (+Y side) is provided on the inner surface of the motor peripheral wall portion 6d. The first hole 92b opens to the stepped surface 81d.

The pipe portion 92a extends along the axial direction. The end portion on the other side (−Y side) in the axial direction of the pipe portion 92a is inserted into the opening of the first hole 92b provided in the stepped surface 81d. On the other hand, the end portion on one side (+Y side) in the axial direction of the pipe portion 92a is inserted into the opening of the first intra-side wall flow path 93 provided in the first side wall portion 6a. Thus, the pipe portion 92a connects the opening of the first hole 92b and the first intra-side wall flow path 93. The fluid O in the pipe portion 92a flows from the other side (−Y side) in the axial direction toward one side (+Y side). The pipe portion 92a is disposed inside the motor accommodating portion 81 and relays between the pump 8 and the first intra-housing flow path 94.

According to the present embodiment, the discharge flow path 92 includes not only the holes (the first hole 92b and the second hole 92c) provided in the wall portion of the housing 6 but also the pipe portion 92a. In a case where the entire length of the discharge flow path 92 is a hole, it is necessary to make a housing of a portion where the hole is provided thick, and the weight of the housing increases. According to the present embodiment, the weight of the housing 6 can be reduced by forming a part of the discharge flow path 92 as the pipe portion 92a.

According to the present embodiment, since the pipe portion 92a is disposed in the internal space of the motor accommodating portion 81, the pipe portion 92a does not protrude from the outer surface of the housing 6. According to the present embodiment, by disposing the pipe portion 92a in the dead space in the motor accommodating portion 81, the drive apparatus 1 can be downsized as compared with the case where the pipe portion 92a is disposed outside.

The first intra-side wall flow path 93 is provided in the wall of the first side wall portion 6a. That is, the first intra-side wall flow path 93 is provided in the wall portion of the housing. The first intra-side wall flow path 93 extends along an orthogonal plane of the motor axis J1. The first intra-side wall flow path 93 is connected to the discharge flow path 92 in the end portion on the upstream side. The first intra-side wall flow path 93 is connected to the inside of the bearing holder 60D in the end portion on the downstream side. The first intra-side wall flow path 93 is connected to the first intra-housing flow path 94 in a region between the end portion on the upstream side and the end portion on the downstream side. The first intra-side wall flow path 93 connects the pipe portion 92a, the first intra-housing flow path 94, and the inside of the bearing holder 60D.

A hollow portion of the motor shaft 21A is opened inside the bearing holder 60D. The fluid O flowing into the bearing holder 60D from the first intra-side wall flow path 93 lubricates the bearing 5D held by the bearing holder 60D and flows into the motor shaft 21A. Therefore, the first intra-side wall flow path 93 is connected to the first intra-shaft flow path 97A in the end portion on the downstream side.

The first intra-side wall flow path 93 has a first region 93a and a second region 93b. The first region 93a connects the discharge flow path 92 and the first intra-housing flow path 94. The second region 93b connects the first intra-housing flow path 94 and the first intra-shaft flow path 97A. A part of the fluid O flowing from the discharge flow path 92 into the first intra-side wall flow path 93 and flowing through the first region 93a flows into the first intra-housing flow path 94, and the other part flows into the second region 93b. The fluid O flowing into the second region 93b flows into the first intra-shaft flow path 97A.

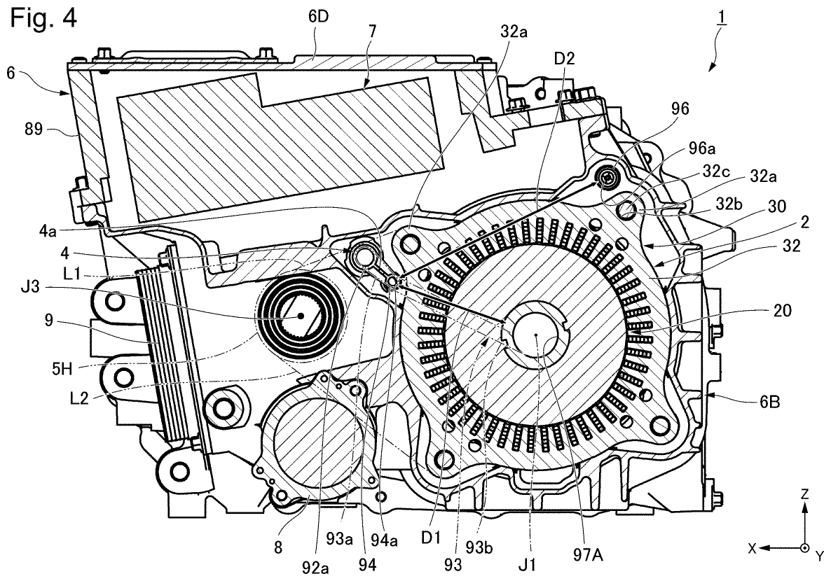

FIG. 4 is a cross-sectional view of the drive apparatus 1 along a cross section orthogonal to the motor axis J1. In FIG. 4, the first intra-side wall flow path 93 is illustrated by a virtual line (two-dot chain line). As illustrated in FIG. 4, the first region 93a is disposed radially outside the motor 2 when viewed from the axial direction. On the other hand, at least a part of the second region 93b overlaps the motor 2 when viewed from the axial direction.

The first intra-side wall flow path 93 of the present embodiment is connected to the first intra-housing flow path 94 in a path extending from the discharge flow path 92 to the first intra-shaft flow path 97A. Therefore, the first intra-side wall flow path 93 can be a continuous flow path that does not branch halfway. According to the present embodiment, it is not necessary to provide a complicated hole in the first side wall portion 6a. As a result, it is possible not only to suppress a decrease in strength of the first side wall portion 6a but also to suppress restriction of arrangement of other configurations attached to the first side wall portion 6a.

The first intra-side wall flow path 93 may be bifurcated inside the first side wall portion 6a and connected to the first intra-shaft flow path 97A and the first intra-housing flow path 94 at a branch destination.

As illustrated in FIG. 1, the first intra-housing flow path 94 is connected to the first intra-side wall flow path 93. The first intra-housing flow path 94 extends along the axial direction inside the motor accommodating portion 81. An end portion on one side (+Y side) in the axial direction of the first intra-housing flow path 94 is inserted into an opening of the first intra-side wall flow path 93 provided in the first side wall portion 6a. On the other hand, the end portion on the other side (−Y side) in the axial direction of the first intra-housing flow path 94 is inserted into the opening of the second intra-side wall flow path 95 provided in the second side wall portion 6b. The fluid O in the first intra-housing flow path 94 flows from one side (+Y side) in the axial direction toward the other side (−Y side).

The first intra-housing flow path 94 is provided with a first feed hole (feed hole) 94a that feeds the fluid O to the motor 2 and a second feed hole (feed hole) 94b that feeds the fluid O to the bearing 5H. The first feed hole 94a and the second feed hole 94b are holes penetrating in the thickness direction of the pipe constituting the first intra-housing flow path 94.

The opening direction of the first feed hole 94a and the opening direction of the second feed hole 94b are opposite to each other in the front-rear direction of the vehicle. More specifically, the opening direction of the first feed hole 94a faces one side in the front-rear direction (−X side, vehicle front side). On the other hand, the opening direction of the second feed hole 94b faces the other side in the front-rear direction (+X side, vehicle rear side).

The first feed hole 94a ejects the fluid O toward the motor 2 by the pressure in the first intra-housing flow path 94. Similarly, the second feed hole 94b ejects the fluid O toward the bearing 5H by the pressure in the first intra-housing flow path 94.

As illustrated in FIG. 4, the first intra-housing flow path 94 is disposed on a side portion of the stator core 32. In the present embodiment, the first intra-housing flow path 94 is disposed on the other side (+X side, vehicle rear side) in the front-rear direction with respect to the stator core 32.

The first intra-housing flow path 94 of the present embodiment is disposed below one fixing portion 32a of the stator core 32. The stator core 32 has a plurality of fixing portions 32a protruding radially outward. The fixing portion 32a is provided with an insert hole 32b penetrating the fixing portion 32a in the axial direction. A bolt 32c extending in the axial direction passes through the insert hole 32b. The bolt 32c is screwed into a screw hole (not illustrated) provided in the inner surface of the housing 6. By fastening the bolt 32c into the screw hole, the fixing portion 32a is fixed to the inner surface of the housing 6. That is, the stator core 32 is fixed to the housing 6 at the fixing portion 32a. The stator core 32 of the present embodiment has four fixing portions 32a. The plurality of fixing portions 32a are disposed at equal intervals along the circumferential direction. The first feed hole 94a of the first intra-housing flow path 94 ejects the fluid O toward the outer peripheral surface of the stator core 32 below one fixing portion 32a.

In the present embodiment, the radial position of the first intra-housing flow path 94 overlaps with the radial position of the fixing portion 32a. According to the present embodiment, the first intra-housing flow path 94 can be disposed close to the outer peripheral surface of the stator core 32, and the fluid O can be efficiently fed from the first feed hole 94a to the stator 30.

As illustrated in FIG. 1, the first intra-housing flow path 94 of the present embodiment is provided with a plurality of first feed holes 94a. The plurality of first feed holes 94a are arranged along the axial direction. As described above, some of the plurality of first feed holes 94a feeds the fluid O to the outer peripheral surface of the stator core 32. The other portions of the plurality of first feed holes 94a feed the fluid O to the coil ends of the coils 31 protruding from one side and the other side in the axial direction of the stator core 32. The fluid O fed to the stator core 32 and the coil 31 takes heat from the stator 30 when flowing along the surfaces of the stator core 32 and the coil 31, and cools the stator 30. Further, the fluid O drops from the stator 30, reaches the lower region of the internal space of the motor accommodating portion 81, and returns to the fluid reservoir P via a through hole (not illustrated) provided in the second side wall portion 6b.

The first intra-housing flow path 94 and the pipe portion 92a of the discharge flow path 92 are coupled to each other by a coupling portion 4a. The first intra-housing flow path 94, the pipe portion 92a, and the coupling portion 4a are formed of the flow path member 4 which is a single member. The configuration of the flow path member 4 will be described in detail later.

The first intra-housing flow path 94 is disposed along the vertical wall region 6k of the second side wall portion 6b. As described above, the through hole 6h is provided in the vertical wall region 6k. The through hole 6h is provided in a portion of the vertical wall region 6k facing the first intra-housing flow path 94. The second feed hole 94b of the first intra-housing flow path 94 faces the internal space of the gear accommodating portion 82 via the through hole 6h.

As illustrated in FIG. 2, the second feed hole 94b, the through hole 6h, and the notch 6g of the bearing holder 60H are disposed side by side in the radial direction of the output axis J3. That is, the second feed hole 94b faces the outer peripheral surface of the bearing 5H via the through hole 6h and the bearing holder 60H. The fluid O ejected from the second feed hole 94b passes through the through hole 6h and the notch 6g and is fed to the bearing 5H. As a result, the fluid O lubricates the bearing 5H.

According to the present embodiment, the fluid O can be fed from the pipe-shaped first intra-housing flow path 94 arranged inside the motor accommodating portion 81 to the bearing 5H disposed inside the gear accommodating portion 82. Therefore, it is not necessary to provide a reservoir (for example, a catch tank) or the like inside the gear accommodating portion 82 for feeding the fluid O to the bearing 5H. As a result, the structure of the gear accommodating portion 82 can be simplified, and the entire drive apparatus 1 can be downsized.

According to the first intra-housing flow path 94 of the present embodiment, the fluid O can be fed to the inside of the accommodating portions (the motor accommodating portion 81 and the gear accommodating portion 82) different from each other. Therefore, the structure of the flow path 90 can be simplified as compared with the case where the flow paths are disposed inside the respective accommodating portions. As a result, the pressure loss in the flow path 90 can be reduced, and the power consumption of the pump 8 can be suppressed. An arrangement space of the flow path 90 can be reduced, and the drive apparatus 1 can be downsized.

According to the present embodiment, as the opening through which the fluid O passes, the through hole 6h is provided in the vertical wall region 6k, and the notch 6g is provided in the cylindrical portion 6f. As a result, even when the direction in which the first intra-housing flow path 94 extends and the output axis J3 that is the center of the bearing 5H are disposed in parallel to each other, the fluid O can be fed to the bearing 5H without being obstructed by the vertical wall region 6k and the cylindrical portion 6f. In other words, it is possible to adopt a configuration in which the extending direction of the first intra-housing flow path 94 is disposed parallel to the output axis J3, and the degree of freedom in the arrangement of the first intra-housing flow path 94 is increased.

In the present embodiment, the case where the two openings of the through hole 6h and the notch 6g are provided in the second side wall portion 6b as the opening through which the fluid O passes has been described. However, the opening through which the fluid O passes is not limited to the present embodiment. That is, the second feed hole 94b may face the bearing 5H through an opening (in the present embodiment, the through hole 6h and the notch 6g) provided in the second side wall portion 6b. That is, the opening is not limited to a specific configuration (shape, posture, direction, number, and the like) as long as it opens a part of the second side wall portion 6b that inhibits the passage of the fluid O between the second feed hole 94b and the bearing 5H.

In the present embodiment, an opening area H1 of the through hole 6h is larger than an opening area H2 of the notch 6g. When the drive apparatus 1 receives large vibration, the ejection direction of the fluid O ejected from the second feed hole 94b swings in the vibration direction. By making the opening area H1 of the through hole 6h sufficiently large, even when the direction of the fluid O ejected from the second feed hole 94b is not stable, the fluid O can be sent into the gear accommodating portion 82. That is, even if the fluid O ejected from the second feed hole 94b cannot be fed to the bearing 5H, at least the fluid O can be sent to the inside of the gear accommodating portion 82, and an increase in the discharge amount to the inside of the motor accommodating portion 81 can be suppressed. When the fluid O is discharged from the second feed hole 94b to the motor accommodating portion 81, the liquid level of the fluid O temporarily accumulated in the motor accommodating portion 81 becomes higher than the lower end of the rotor 20, and there is a possibility that the stirring resistance of the rotor 20 increases. According to the present embodiment, it is possible to suppress an increase in the liquid level of the fluid O inside the motor accommodating portion 81. On the other hand, if the opening area H2 of the notch 6g is too large, the rigidity of the bearing holder 60H may decrease, leading to unstable holding of the bearing 5H. Therefore, the opening area H2 of the notch 6g is limited, and it is difficult to make the opening area H2 larger than the opening area H1 of the through hole 6h. According to the present embodiment, by setting the opening areas H1 and H2 to the above-described relationship, it is possible to suppress an increase in the liquid level of the fluid O inside the motor accommodating portion 81 while stabilizing the holding of the bearing 5H by the bearing holder 60H.

The opening area H2 of the notch 6g in the present specification is an area of a region surrounded by an inner edge of the notch 6g and an extension line of a tip edge of the bearing holder 60H when the notch 6g is viewed from the radial direction of the output axis J3.

In the present embodiment, the second feed hole 94b, the opening (in the present embodiment, the through hole 6h and the notch 6g) of the second side wall portion 6b, and the bearing 5H are arranged along the direction intersecting the axial direction of the motor axis J1. Therefore, when the first intra-housing flow path 94 is disposed in parallel with the motor axis J1, the fluid O can be directly fed from the first intra-housing flow path 94 to the bearing 5H, and the bearing 5H can be efficiently lubricated.

As illustrated in FIG. 4, the first intra-housing flow path 94 is disposed between the motor axis J1 and the output axis J3 parallel to each other in the front-rear direction (X-axis direction) of the vehicle. That is, the first intra-housing flow path 94 is disposed between the motor axis J1 and the output axis J3 when viewed from the up-down direction. According to the present embodiment, the first intra-housing flow path 94 can be disposed between the motor 2 and the bearing 5H in the front-rear direction of the vehicle, and can be brought close to each of the motor 2 and the bearing 5H. As a result, the fluid O can be efficiently fed from the first intra-housing flow path 94 to the motor 2 and the bearing 5H.

As illustrated in FIG. 4, a first common tangent line L1 and a second common tangent line L2 respectively contacting the outer shape of the motor 2 and the outer shape of the bearing 5H are assumed when viewed from the axial direction of the motor axis J1. In the present embodiment, the first common tangent line L1 and the second common tangent line L2 are in contact with different fixing portions 32a of the stator core 32. The first intra-housing flow path 94 is preferably disposed in a region surrounded by the motor 2, the bearing 5H, the first common tangent line L1, and the second common tangent line L2. As a result, the first intra-housing flow path 94 can be brought close to both the motor 2 and the bearing 5H, and the fluid O can be efficiently fed from the first intra-housing flow path 94 to the motor 2 and the bearing 5H.

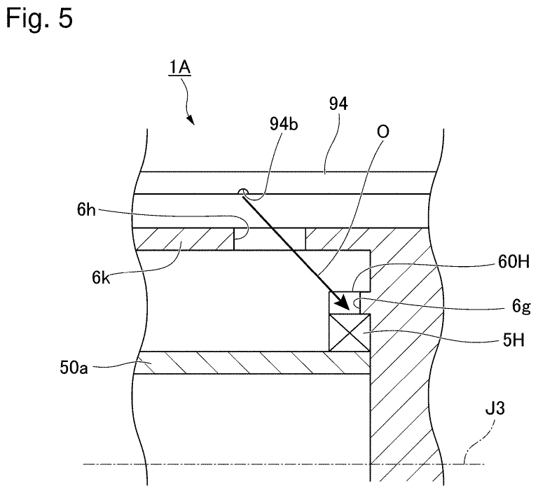

In the present embodiment, the second feed hole 94b, the through hole 6h, the notch 6g, and the bearing 5H are linearly arranged in the radial direction of the output axis J3. However, as illustrated in a drive apparatus 1A of the modification of FIG. 5, the second feed hole 94b, the through hole 6h, the notch 6g, and the bearing 5H may be disposed side by side in a straight line inclined in the axial direction toward the radially outer side. Even in this case, the fluid O can be fed to the bearing 5H by providing the second feed hole 94b such that the ejection direction of the fluid O faces the bearing 5H side.

As illustrated in FIG. 1, the second intra-side wall flow path 95 is connected to the first intra-housing flow path 94. The second intra-side wall flow path 95 is provided in the wall of the second side wall portion 6b. The second intra-side wall flow path 95 extends along an orthogonal plane of the motor axis J1. The second intra-side wall flow path 95 is connected to the first intra-housing flow path 94 in the end portion on the upstream side. The second intra-side wall flow path 95 is connected to the second intra-housing flow path 96 and the third intra-housing flow path 98 in the end portion on the downstream side. The second intra-side wall flow path 95 connects the first intra-housing flow path 94, the second intra-housing flow path 96, and the third intra-housing flow path 98.

The second intra-side wall flow path 95 has a feed portion 95a connected to the inside of the bearing holder 60F. The feed portion 95a can feed the fluid O flowing through the second intra-side wall flow path 95 to the inside of the bearing holder 60F to lubricate the bearing 5F held by the bearing holder 60F. According to the present embodiment, the bearing 5F can be lubricated without providing a reservoir or the like inside the gear accommodating portion 82 for feeding a fluid to the bearing 5F.

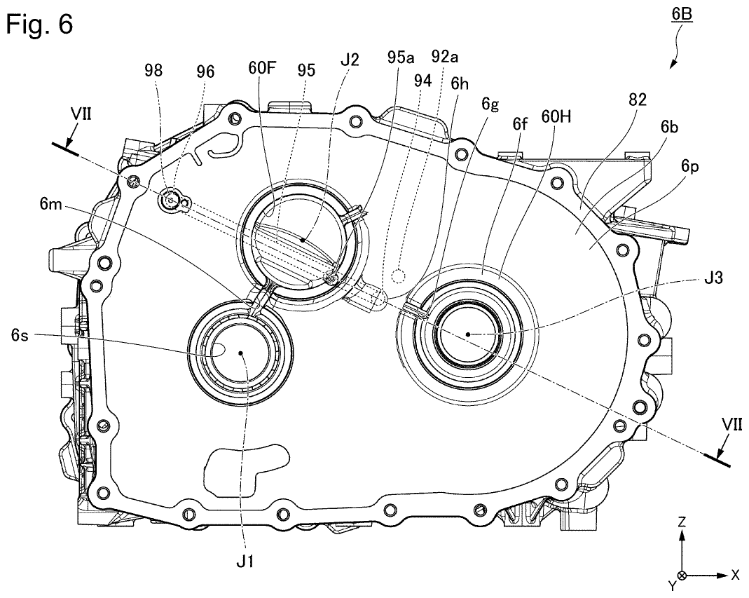

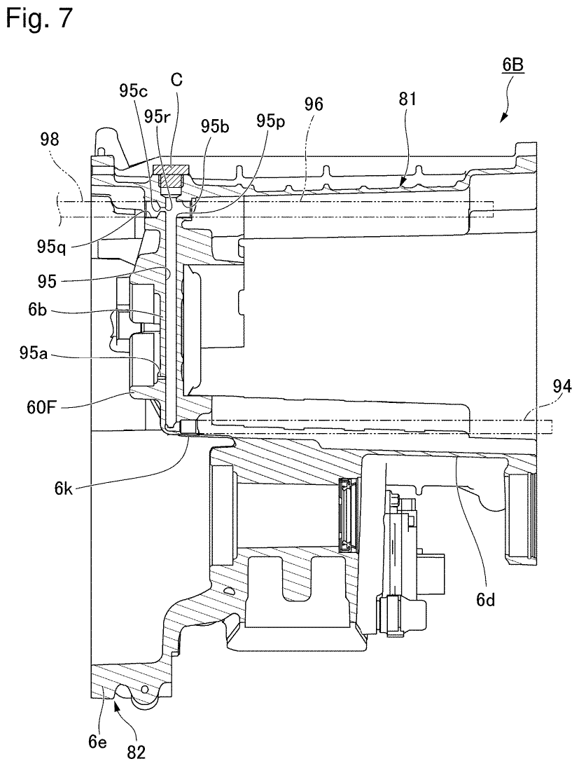

FIG. 6 is a front view of the housing body 6B when viewed from the gear accommodating portion 82 side. FIG. 7 is a cross-sectional view of the housing body 6B taken along line VII-VII of FIG. 6.

As illustrated in FIG. 6, the second intra-side wall flow path 95 overlaps the bearing holder 60F when viewed from the axial direction of the motor axis J1. The feed portion 95a is a hole connected from the second intra-side wall flow path 95 to the bearing holder 60F. The feed portion 95a extends from the second intra-side wall flow path 95 to the other side (−Y side) in the axial direction. The feed portion 95a is located in a region where the second intra-side wall flow path 95 and the bearing holder 60F overlap each other when viewed from the axial direction.

According to the present embodiment, the second intra-side wall flow path 95 and the bearing holder 60F overlap each other when viewed from the axial direction. Therefore, the flow path of the feed portion 95a connecting the second intra-side wall flow path 95 and the bearing holder 60F can be shortened. Therefore, not only the pressure loss in the feed portion 95a can be reduced, but also the reduction in the strength of the second side wall portion 6b due to the provision of the feed portion 95a can be suppressed.

The first gear facing surface 6p of the second side wall portion 6b is provided with a recessed groove portion 6m. The recessed groove portion 6m connects the bearing holder 60F centered on the intermediate axis J2 and the shaft passing hole 6s centered on the motor axis J1. In the present embodiment, the intermediate axis J2 is disposed above the motor axis J1. Therefore, the fluid O is fed to the bearing holder 60F from the second intra-side wall flow path 95 is fed to the shaft passing hole 6s via the recessed groove portion 6m. As a result, the bearings 5B and 5C disposed inside the shaft passing hole 6s are lubricated.

As illustrated in FIG. 7, the end portion on the downstream side of the second intra-side wall flow path 95 is connected to the second intra-housing flow path 96 and the third intra-housing flow path 98. The second intra-housing flow path 96 is disposed in the internal space of the motor accommodating portion 81 expanding on one side (+Y side) in the axial direction of the second side wall portion 6b. On the other hand, the third intra-housing flow path 98 is disposed in the internal space of the gear accommodating portion 82 expanding to the other side (−Y side) in the axial direction of the second side wall portion 6b. Therefore, the second intra-housing flow path 96 and the third intra-housing flow path 98 extend to the opposite side in the axial direction with respect to the second intra-side wall flow path 95.

A first insertion hole 95p opening to one side (+Y side) in the axial direction and a second insertion hole 95q opening to the other side (−Y side) in the axial direction are provided in the end portion on the downstream side of the second intra-side wall flow path 95. The first insertion hole 95p and the second insertion hole 95q overlap each other when viewed from the axial direction of the motor axis J1. The first insertion hole 95p and the second insertion hole 95q are coaxially disposed.

A pipe constituting the second intra-housing flow path 96 is inserted into the first insertion hole 95p, and a pipe constituting the third intra-housing flow path 98 is inserted into the second insertion hole 95q. The cross-sectional area of the first insertion hole 95p is substantially uniform. On the other hand, the second insertion hole 95q is provided with a reduced diameter portion 95r whose cross-sectional area is partially reduced.

A first boundary portion 95b is provided in the first insertion hole 95p of the second intra-side wall flow path 95. The first boundary portion 95b is an axially extending region located between the tip of the second intra-housing flow path 96 inserted into the first insertion hole 95p and a portion extending orthogonal to the axial direction of the second intra-side wall flow path 95. Similarly, a second boundary portion 95c is provided in the second insertion hole 95q of the second intra-side wall flow path 95. The second boundary portion 95c is an axially extending region located between the tip of the third intra-housing flow path 98 inserted into the second insertion hole 95q and a portion extending orthogonal to the axial direction of the second intra-side wall flow path 95. That is, the second intra-side wall flow path 95 has the first boundary portion 95b at the boundary with the second intra-housing flow path 96, and has the second boundary portion 95c at the boundary with the third intra-housing flow path 98. The second boundary portion 95c is provided with the reduced diameter portion 95r.

According to the present embodiment, the cross-sectional area of the first boundary portion 95b is larger than the cross-sectional area of the second boundary portion 95c. Therefore, the fluid O flowing through the second intra-side wall flow path 95 flows into the second intra-housing flow path 96 more than the third intra-housing flow path 98. As described later, the fluid O fed to the second intra-housing flow path 96 is mainly fed to the motor 2 to cool the motor 2. On the other hand, the fluid O fed to the third intra-housing flow path 98 is mainly fed to the transmission mechanism 3 to lubricate the transmission mechanism 3. According to the present embodiment, in a case where cooling of the motor 2 is prioritized over lubrication of the transmission mechanism 3, it is possible to feed more fluid O to the motor 2 than to the transmission mechanism 3.

According to the present embodiment, the first boundary portion 95b and the second boundary portion 95c overlap each other when viewed from the axial direction of the motor axis J1. Therefore, when viewed from the axial direction, the second intra-housing flow path 96 and the third intra-housing flow path 98 are disposed at the same position, and the projected area of the housing 6 in the axial direction can be reduced. According to the present embodiment, it is possible to reduce the size of the drive apparatus 1.

As illustrated in FIG. 1, the second intra-housing flow path 96 is connected to the second intra-side wall flow path 95. The second intra-housing flow path 96 extends along the axial direction inside the motor accommodating portion 81. An end portion on one side (+Y side) in the axial direction of the second intra-housing flow path 96 is fixed to the inner surface of the housing 6. On the other hand, the end portion on the other side (−Y side) in the axial direction of the second intra-housing flow path 96 is inserted into the opening of the second intra-side wall flow path 95 provided in the second side wall portion 6b. The fluid O in the second intra-housing flow path 96 flows from the other side (−Y side) in the axial direction toward one side (+Y side).

A gap is provided between the end portion on one side (+Y side) in the axial direction of the second intra-housing flow path 96 and the first side wall portion 6a. A stepped surface 81e facing one side (+Y side) in the axial direction is provided on the inner surface of the motor peripheral wall portion 6d. The second intra-housing flow path 96 is screwed to the stepped surface 81e from one side (+Y side) in the axial direction at an attachment portion 81f in the end portion on one side (+Y side) in the axial direction. The second intra-housing flow path 96 of the present embodiment can be fixed to the housing body 6B in a state where the motor cover 6A is opened. According to the present embodiment, the second intra-housing flow path 96 can be easily assembled as compared with the case where both end portions of the second intra-housing flow path 96 are each fixed to the first side wall portion 6a and the second side wall portion 6b.

The second intra-housing flow path 96 is provided with a third feed hole (feed hole) 96a for feeding the fluid O to the motor 2. The third feed hole 96a is a hole penetrating in the thickness direction of the pipe constituting the second intra-housing flow path 96. The third feed hole 96a ejects the fluid O toward the motor 2 by the pressure in the second intra-housing flow path 96.

As illustrated in FIG. 4, the second intra-housing flow path 96 is disposed on the side portion of the stator core 32. In the present embodiment, the second intra-housing flow path 96 is disposed directly above the stator core 32. In this specification, “directly above” means that they are disposed so as to overlap each other when viewed from above and the up-down direction.

As described above, the stator core 32 has the fixing portion 32a protruding radially outward. In the present embodiment, the radial position of the second intra-housing flow path 96 overlaps the radial position of the fixing portion 32a. According to the present embodiment, the second intra-housing flow path 96 can be disposed close to the outer peripheral surface of the stator core 32, and the fluid O can be efficiently fed from the third feed hole 96a to the stator 30.

According to the present embodiment, the fluid O is fed to the outer peripheral surface of the motor 2 from each of the first feed hole 94a of the first intra-housing flow path 94 and the third feed hole 96a of the second intra-housing flow path 96. As a result, the fluid O can be fed to the entire outer peripheral surface of the motor 2, and it is possible to prevent a local high-temperature portion from being provided on the surface of the motor 2.

In the present embodiment, the first intra-housing flow path 94 and the second intra-housing flow path 96 are disposed on both sides of one fixing portion 32a in the circumferential direction, and extend in parallel along the axial direction of the motor axis J1. According to the present embodiment, the fluid O can be fed from the first intra-housing flow path 94 and the second intra-housing flow path 96 to the outer peripheral surfaces of the stator core 32 on both sides of one fixing portion 32a.

According to the present embodiment, the flow path (the first intra-side wall flow path 93) for feeding the fluid O to the first intra-housing flow path 94 and the flow path (the second intra-side wall flow path 95) for feeding the fluid O to the second intra-housing flow path 96 are provided in the side wall portions (the first side wall portion 6a and the second side wall portion 6b) disposed opposite to each other in the axial direction. Therefore, the fluid O flows in the first intra-housing flow path 94 and the second intra-housing flow path 96 in opposite directions.

When the two intra-housing flow paths are connected to the flow path in the side wall portion on one side in the axial direction with respect to the motor, the intra-side wall flow path tends to be long and complicated. According to the present embodiment, the first intra-housing flow path 94 is connected to the first intra-side wall flow path 93 on one side (+Y side) in the axial direction of the motor 2, and the second intra-housing flow path 96 is connected to the second intra-side wall flow path 95 on the other side (−Y side) in the axial direction of the motor 2. Therefore, each of the intra-side wall flow paths (the first intra-side wall flow path 93 and the second intra-side wall flow path 95) can be shortened and simplified. As a result, it is possible to suppress a decrease in strength and rigidity of the first side wall portion 6a and the second side wall portion 6b. In addition, it is possible to suppress restriction of arrangement of other configurations attached to the first side wall portion 6a and the second side wall portion 6b, as compared with a case where complicated intra-side wall flow paths are concentratedly disposed on any one of the first side wall portion 6a and the second side wall portion 6b.

As illustrated in FIG. 1, the third intra-housing flow path 98 is connected to the second intra-side wall flow path 95. The third intra-housing flow path 98 extends along the axial direction inside the gear accommodating portion 82. The fluid O in the third intra-housing flow path 98 flows from one side (+Y side) in the axial direction toward the other side (−Y side). An end portion on one side (+Y side) in the axial direction of the third intra-housing flow path 98 is inserted into an opening of the second intra-side wall flow path 95 provided in the second side wall portion 6b.

The third intra-housing flow path 98 is provided with a fourth feed hole (feed hole) 98a for feeding the fluid O to the transmission mechanism 3. The fourth feed hole 98a is a hole penetrating in the thickness direction of the pipe constituting the third intra-housing flow path 98. The fourth feed hole 98a ejects the fluid O toward the transmission mechanism 3 by the pressure in the third intra-housing flow path 98. According to the present embodiment, the fluid O can be fed from the flow path 90 to the transmission mechanism 3 to lubricate the transmission mechanism 3 without providing a configuration for feeding the fluid O such as a reservoir in the gear accommodating portion 82.

In the present embodiment, the opening of the fourth feed hole 98a faces the first gear 41 or the second gear. Therefore, the fluid O ejected from the fourth feed hole 98a is fed to the first gear 41 or the second gear 42. In the present embodiment, the first gear 41 and the second gear mesh with each other. Therefore, by feeding the fluid O from the fourth feed hole 98a to any one of the first gear 41 and the second gear 42, the tooth surfaces of both gears can be lubricated with the fluid O. As in the present embodiment, the transmission mechanism 3 is provided with the ring gear 51 that rotates about the output axis J3. The ring gear 51 generally has a larger diameter than other gears and is likely to be immersed in the fluid reservoir P. Therefore, it is not always necessary to feed the fluid O to the ring gear 51 and the third gear 43 meshing with the ring gear 51. When the fluid O is fed to the first gear 41 or the second gear 42 as in the present embodiment, lubrication of all the gears of the transmission mechanism 3 can be maintained, and the operation of the transmission mechanism 3 can be performed smoothly.

As illustrated in FIG. 1, the third intra-side wall flow path 99 is connected to the third intra-housing flow path 98. The third intra-side wall flow path 99 is provided in the wall of the third side wall portion 6c. The third intra-side wall flow path 99 extends along a plane orthogonal to the motor axis J1. The third intra-side wall flow path 99 includes a first flow path portion 99A and a second flow path portion 99B. The first flow path portion 99A is a region on the upstream side of the third intra-side wall flow path 99, and the second flow path portion 99B is a region on the downstream side of the third intra-side wall flow path 99.

The first flow path portion 99A is connected to the third intra-housing flow path 98 in the end portion on the upstream side. The first flow path portion 99A is connected to the inside of the bearing holder 60E in the end portion on the downstream side. The second flow path portion 99B is connected to the inside of the bearing holder 60E in the end portion on the upstream side. The second flow path portion 99B is connected to the inside of the bearing holder 60A in the end portion on the downstream side.

As illustrated in FIG. 3, the first flow path portion 99A is a recessed groove provided on the second gear facing surface 6q of the third side wall portion 6c facing the transmission mechanism 3. The fluid O discharged from the end portion of the third intra-housing flow path 98 flows into the first flow path portion 99A. The fluid O in the first flow path portion 99A flows into the bearing holder 60E by gravity.

As illustrated in FIG. 1, a hollow portion of the second shaft 45 is opened inside the bearing holder 60E. The fluid O flowing into the bearing holder 60E from the first flow path portion 99A of the third intra-side wall flow path 99 lubricates the bearing 5E held by the bearing holder 60E, and flows into the inside of the second shaft 45 and the second flow path portion 99B. A part of the fluid O flowing into the second shaft 45 reaches one side (+Y side) in the axial direction of the second shaft 45 and lubricates the bearing 5F.

As illustrated in FIG. 3, the second flow path portion 99B is a through hole penetrating the cylindrical portion of the bearing holder 60E centered on the intermediate axis J2 and the cylindrical portion of the bearing holder 60A centered on the motor axis J1. The second flow path portion 99B extends along the up-down direction. In the present embodiment, the intermediate axis J2 is disposed above the motor axis J1. Therefore, a part of the fluid O inside the bearing holder 60E flows through the second flow path portion 99B by gravity and flows into the inside of the bearing holder 60A.

As illustrated in FIG. 1, a hollow portion of the first shaft 21B opens inside the bearing holder 60A. The fluid O flowing into the bearing holder 60A from the second flow path portion 99B of the third intra-side wall flow path 99 lubricates the bearing 5A held by the bearing holder 60A and flows into the first shaft 21B. Therefore, the end portion on the downstream side portion of the third intra-side wall flow path 99 is connected to the second intra-shaft flow path 97B.

According to the present embodiment, the third intra-side wall flow path 99 feeds the fluid O to the bearings 5A and 5E held by the third side wall portion 6c. According to the present embodiment, the bearings 5A and 5E can be lubricated without providing a reservoir or the like for feeding fluid to the bearings 5A and 5E inside the gear accommodating portion 82.

The first intra-shaft flow path 97A is connected to the first intra-side wall flow path 93 and is provided in the hollow portion of the motor shaft 21A. That is, the first intra-shaft flow path 97A is a path of the fluid O passing through the hollow portion of the motor shaft 21A. In the first intra-shaft flow path 97A, the fluid O flows from one side (+Y side) in the axial direction toward the other side (−Y side).

The motor shaft 21A is provided with a communicating hole 21p that extends in the radial direction and communicates the inside and the outside of the motor shaft 21A. The fluid O in the first intra-shaft flow path 97A is scattered radially outward through the communicating hole 21p by a centrifugal force accompanying the rotation of the motor shaft 21A and is fed to the stator 30.

In the present embodiment, the coupling body of the shaft constituting the first intra-shaft flow path 97A extends between the first side wall portion 6a and the third side wall portion 6c. Therefore, in order to feed the fluid O to the first intra-shaft flow path 97A, it is necessary to send the fluid O from one of the first side wall portion 6a and the third side wall portion 6c to the inside of the shaft. The flow path 90 of the present embodiment feeds the fluid O from the first side wall portion 6a on one side (+Y side) in the axial direction of the motor 2 to the first intra-shaft flow path 97A. Therefore, as compared with the case where the fluid O is fed from the third side wall portion 6c to the first intra-shaft flow path 97A, the distance between the pump 8 disposed on the outer periphery of the motor accommodating portion 81 and the first intra-shaft flow path 97A is easily shortened. As a result, the passage resistance of the flow path connecting the pump 8 and the first intra-shaft flow path 97A can be suppressed, and a large amount of fluid O can be fed to the first intra-shaft flow path 97A.

As illustrated in FIG. 4, when viewed from the axial direction of the motor axis J1, a distance D1 between the first intra-housing flow path 94 and the first intra-shaft flow path 97A is shorter than a distance D2 between the first intra-housing flow path 94 and the second intra-housing flow path 96. According to the present embodiment, the first intra-shaft flow path 97A is relatively close to the first intra-housing flow path 94. Therefore, even if the first intra-housing flow path 94 and the first intra-shaft flow path 97A are connected by the first intra-side wall flow path 93, problems such as the first intra-side wall flow path 93 being long and complicated are less likely to occur.

As illustrated in FIG. 1, the second intra-shaft flow path 97B is connected to the third intra-side wall flow path 99 and is provided in the hollow portion of the first shaft 21B. That is, the second intra-shaft flow path 97B is a path of the fluid O passing through the hollow portion of the first shaft 21B. In the second intra-shaft flow path 97B, the fluid O flows from the other side (−Y side) in the axial direction toward one side (+Y side).

The fluid O flowing through the second intra-shaft flow path 97B merges with the fluid flowing through the first intra-shaft flow path 97A. The merged fluid O leaks from the coupling portion between the motor shaft 21A and the first shaft 21B, is fed to the bearings 5B and 5C held by the second side wall portion 6b, and lubricates the bearings 5B and 5C.

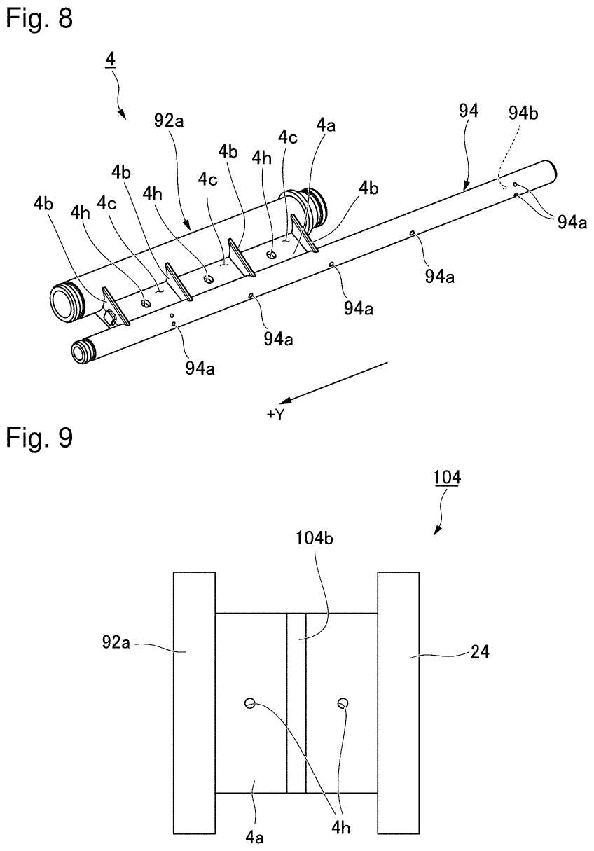

FIG. 8 is a perspective view of a flow path member 4 of the present embodiment.

The flow path member 4 includes a first intra-housing flow path 94, a pipe portion 92a, a coupling portion 4a that couples the first intra-housing flow path 94 and the pipe portion 92a, and a plurality of ribs 4b that reinforce the coupling portion 4a.

According to the present embodiment, the pipe portion 92a that relays between the pump 8 and the first intra-housing flow path 94 is coupled to the first intra-housing flow path 94. Therefore, the assembly process can be simplified as compared with a case where the first intra-housing flow path 94 and the pipe portion 92a are separately assembled to the housing 6. In particular, in the present embodiment, since the first intra-housing flow path 94 and the pipe portion 92a are formed of a single member (flow path member 4), the number of components can be reduced to achieve cost reduction.

According to the present embodiment, the pipe portion 92a and the first intra-housing flow path 94 extend in parallel with each other. The coupling portion 4a of the present embodiment has a plate shape extending along the extending direction of the pipe portion 92a and the first intra-housing flow path 94. The coupling portion 4a is provided with a through hole 4h. The through hole 4h penetrates the coupling portion 4a in the thickness direction.

The flow path member 4 is disposed along the outer peripheral surface of the motor 2. The fluid O is fed to the motor 2 from feed holes (first feed hole 94a, third feed hole 96a) of the first intra-housing flow path 94 and the second intra-housing flow path 96. For this reason, the fluid O bouncing off the outer peripheral surface of the motor 2 is applied to the flow path member 4. According to the present embodiment, since the through hole 4h is provided in the coupling portion 4a, the fluid O applied to the coupling portion 4a can be dropped downward, and accumulation of the fluid O on the upper side of the coupling portion 4a can be suppressed.

The rib 4b of the present embodiment has a plate shape extending along a plane orthogonal to the extending direction of the pipe portion 92a and the first intra-housing flow path 94. The plurality of ribs 4b are arranged at equal intervals along the extending direction of the pipe portion 92a and the first intra-housing flow path 94. Each rib 4b is connected to the outer periphery of the pipe portion 92a, the outer periphery of the first intra-housing flow path 94, and the coupling portion 4a.

The flow path member 4 is provided with a recess 4c surrounded by the pipe portion 92a, the first intra-housing flow path 94, the coupling portion 4a, and the rib 4b. The flow path member 4 of the present embodiment is provided with three recesses 4c. The fluid O scattered in the flow path member 4 tends to accumulate in the three recesses 4c. The through hole 4h of the present embodiment is disposed in the coupling portion 4a constituting each recess 4c. Therefore, the through hole 4h can discharge the fluid O accumulated in each recess 4c. The through hole 4h can discharge the fluid O accumulated in the recess 4c as long as the through hole 4h is disposed on any surface constituting the recess 4c. Therefore, the through hole 4h may be provided in at least one of the coupling portion 4a and the rib 4b.

As illustrated in FIG. 4, the first intra-housing flow path 94 is disposed below the pipe portion 92a when viewed in the direction in which the pipe portion 92a and the first intra-housing flow path 94 extend (in the axial direction of the motor axis J1 in the present embodiment). Since one of the pipe portion 92a and the first intra-housing flow path is disposed below the other in this manner, the flow path member 4 can be disposed in an inclined manner, and the fluid O scattering toward the flow path member 4 can be suppressed from accumulating in the flow path member 4.

In the present embodiment, the first intra-housing flow path 94 is disposed above the motor axis J1 and the output axis J3. As described above, the first intra-housing flow path 94 feeds the fluid O to each of the motor 2 disposed around the motor axis J1 and the bearing 5H disposed around the output axis J3. According to the present embodiment, since the first intra-housing flow path 94 is disposed above the motor axis J1 and the output axis J3, the fluid O can be fed to the motor 2 and the bearing 5H using gravity. Further, in the present embodiment, the first intra-housing flow path 94 is disposed below the pipe portion 92a. According to the present embodiment, by using the pipe disposed on the lower side of the pipe portion 92a and the first intra-housing flow path 94 as the first intra-housing flow path 94, the first intra-housing flow path 94 can be disposed close to the motor 2 and the bearing 5H, and the fluid O can be efficiently fed.

In the present embodiment, the distance between the first intra-housing flow path 94 and the motor axis J1 is shorter than the distance between the pipe portion 92a and the motor axis J1. As described above, the fluid O can be efficiently fed to the motor 2 by disposing the first intra-housing flow path 94 for feeding the fluid O to the motor 2, of the pipe portion 92a and the first intra-housing flow path 94, close to the motor axis J1.

As illustrated in FIG. 1, in the present embodiment, the flow direction of the fluid O flowing through the pipe portion 92a and the flow direction of the fluid O flowing through the first intra-housing flow path 94 are opposite to each other. According to the present embodiment, the fluid O can be fed to the first intra-housing flow path 94 using the pipe portion 92a.

In the present embodiment, the case where the rib 4b extends along the plane orthogonal to the direction in which the pipe portion 92a and the first intra-housing flow path 94 extend has been described. However, the configuration of the rib 4b is not limited to the present embodiment. As shown in the flow path member 104 of the modification illustrated in FIG. 9, a rib 104b may extend in the same direction as the extending direction of the pipe portion 92a and the first intra-housing flow path 94.

The refrigerant flow path 70 illustrated in FIG. 1 is a flow path through which the refrigerant L flows. The refrigerant L flowing in the refrigerant flow path 70 is, for example, water. The refrigerant flow path 70 is provided in the housing 6. The refrigerant flow path 70 includes an external refrigerant pipe 71 passing through the outside of the housing 6 and an internal refrigerant flow path 72 passing through the inside of the housing 6. The inverter 7 and the cooler 9 are disposed in the path of the refrigerant flow path 70.

The external refrigerant pipe 71 is a pipe connected to the housing 6. The external refrigerant pipe 71 of the present embodiment is connected to the inverter accommodating portion 89 and the side portion of the motor accommodating portion 81. The internal refrigerant flow path 72 is a hole extending inside the housing 6. The internal refrigerant flow path 72 connects the external refrigerant pipe 71 and the cooler 9. A radiator (not illustrated) is disposed in the path of the external refrigerant pipe 71. The radiator cools the refrigerant L flowing through the refrigerant flow path 70.

The refrigerant flow path 70 passes through the inverter 7 and the cooler 9 in this order from a radiator (not illustrated) and returns to the radiator. In the cooler 9, the refrigerant L exchanges heat with the fluid O flowing through the flow path 90 to cool the fluid O. The refrigerant L cools the inverter 7 in the course of passing through the inverter 7.

In the present embodiment, a case where oil is employed as the fluid O and cooling water is employed as the refrigerant L will be described, but the present invention is not limited thereto. For example, both the fluid O and the refrigerant L may be oil. Even in this case, it is sufficient that the flow path 90 and the refrigerant flow path 70 are provided in paths independent from each other, and the oils flowing inside do not mix with each other.

Next, various modifications that can be adopted in the above-described embodiment will be described. In the description of each modification described below, the same reference numerals are given to the same components as those of the embodiment and modification described above, and the description thereof will be omitted.

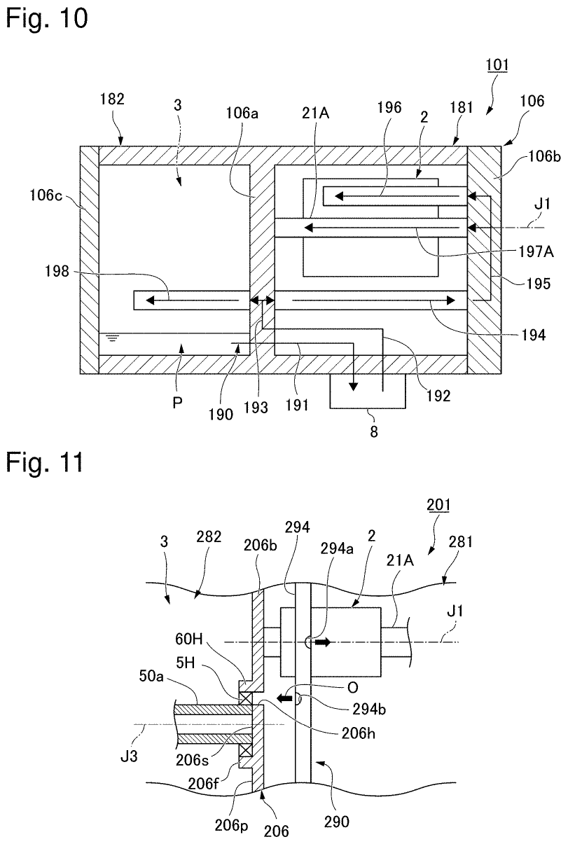

FIG. 10 is a schematic cross-sectional view of a drive apparatus 101 according to Modification 1.

The drive apparatus 101 of the present modification is different from the above-described embodiment mainly in the configurations of a first intra-side wall flow path 193, a first intra-housing flow path 194, and a second intra-side wall flow path 195.

Similarly to the above-described embodiment, the housing 106 of the present modification includes a motor accommodating portion 181 and a gear accommodating portion 182. The gear accommodating portion 182 is provided with the fluid reservoir P that stores the fluid O. The housing 106 of the present modification includes a first side wall portion 106a, a second side wall portion 106b, and a third side wall portion 106c extending along a plane orthogonal to the motor axis J1.

In the present modification, the first side wall portion 106a is located on the other side (−Y side) in the axial direction of the motor 2, and defines the internal space of the motor accommodating portion 181 and the internal space of the gear accommodating portion 182. The second side wall portion 106b is located on one side (+Y side) in the axial direction of the motor 2. The third side wall portion 106c is disposed on the other side (−Y side) in the axial direction of the transmission mechanism 3.

A flow path 190 of the present modification includes a suction flow path 191, a discharge flow path 192, a first intra-side wall flow path 193, a first intra-housing flow path 194, a second intra-side wall flow path 195, a second intra-housing flow path 196, a first intra-shaft flow path 197A, and a third intra-housing flow path 198. The flow path 190 of the present modification may further include a third intra-side wall flow path 99 and a second intra-shaft flow path 97B similar to those of the above-described embodiment. In this case, the third intra-side wall flow path 99 is connected to the third intra-housing flow path 198, and the second intra-shaft flow path 97B is connected to the third intra-side wall flow path 99.

The suction flow path 191 connects the fluid reservoir P and the pump 8. The discharge flow path 192 extends from the pump 8 to the first side wall portion 106a. The discharge flow path 192 connects the pump 8 and the first intra-side wall flow path 193. The first intra-side wall flow path 193 is connected to the first intra-housing flow path 194 and is provided in the wall of the first side wall portion 106a.

The first intra-housing flow path 194 extends along the axial direction inside the motor accommodating portion 181. The fluid O in the first intra-housing flow path 194 flows from the other side (−Y side) in the axial direction toward one side (+Y side).

The third intra-housing flow path 198 is connected to the first intra-side wall flow path 193 and extends inside the gear accommodating portion 182 along the axial direction. The fluid O in the third intra-housing flow path 198 flows from one side (+Y side) in the axial direction toward the other side (−Y side).

The second intra-side wall flow path 195 is connected to the first intra-housing flow path 194 and is provided in the wall of the second side wall portion 106b.

The first intra-shaft flow path 197A is connected to the second intra-side wall flow path 195 and is provided in the hollow portion of the motor shaft 21A.

The second intra-housing flow path 196 is connected to the second intra-side wall flow path 195 and extends inside the motor accommodating portion 181 along the axial direction. The fluid O in the second intra-housing flow path 196 flows from one side (+Y side) in the axial direction toward the other side (−Y side).

According to the present modification, the side wall portion (first side wall portion 106a) that feeds the fluid O to the first intra-housing flow path 194 and the side wall portion (second side wall portion 106b) that feeds the fluid O to the second intra-housing flow path 196 are disposed on the opposite side in the axial direction across the motor 2. Therefore, as compared with a case where the fluid O is fed from one intra-side wall flow path to the first intra-housing flow path 194 and the second intra-housing flow path 196, the respective intra-side wall flow paths 193 and 195 can be shortened and simplified, and it is possible to suppress deterioration in strength and rigidity of the first side wall portion 106a and the second side wall portion 106b. In addition, it is possible to suppress restriction of arrangement of other configurations attached to the first side wall portion 106a and the second side wall portion 106b as compared with a case where a complicated intra-side wall flow path is disposed in any one of the first side wall portion 106a and the second side wall portion 106b.

FIG. 11 is a schematic cross-sectional view of a drive apparatus 201 according to Modification 2.

The drive apparatus 201 of the present modification is different from the above-described embodiment mainly in the configuration of a first intra-housing flow path 294.

Similarly to the above-described embodiment, a housing 206 of the present modification includes a motor accommodating portion 281 and a gear accommodating portion 282. The housing 206 of the present modification includes a side wall portion 206b that defines the internal space of the motor accommodating portion 281 and the internal space of the gear accommodating portion 282.

The side wall portion 206b is provided with a first gear facing surface (gear facing surface) 206p facing the transmission mechanism 3 (not illustrated in FIG. 11). The bearing holder 60H that supports the differential case shaft 50a of the transmission mechanism 3 via the bearing 5H is provided on the first gear facing surface 206p.

The bearing holder 60H has a cylindrical portion 206f protruding from the first gear facing surface 206p and surrounding the bearing 5H. The side wall portion 206b has a bottom region 206s surrounded by the cylindrical portion 206f. A through hole (opening) 206h penetrating the side wall portion 206b in the thickness direction is provided in the bottom region 206s. The through hole 206h overlaps the bearing 5H when viewed from the axial direction of the output axis J3. Therefore, the through hole 206h exposes the bearing 5H to the internal space of the motor accommodating portion 281. A second feed hole 294b of the first intra-housing flow path 294 opens toward the through hole 206h and the bearing 5H.

The flow path 290 of the present modification includes the first intra-housing flow path 294 extending inside the motor accommodating portion 281. The first intra-housing flow path 294 extends along a plane orthogonal to the motor axis J1. The first intra-housing flow path 294 is provided with a first feed hole 294a and a second feed hole 294b. The first feed hole 294a feeds the fluid O to the motor 2. On the other hand, the second feed hole 294b feeds the fluid O to the bearing 5H.

The fluid O ejected from the second feed hole 294b passes through the through hole 206h and is fed to the bearing 5H. As a result, the fluid O lubricates the bearing 5H. According to the present modification, the bearing 5H disposed in the gear accommodating portion 282 can be lubricated from the pipe-shaped first intra-housing flow path 294 disposed in the motor accommodating portion 281.

In the present modification, the case where the through hole 206h is provided in the bottom region 206s as the opening through which the fluid O from the second feed hole 294b passes has been described. Even with such a configuration, the fluid O ejected from the second feed hole 294b can be fed to the bearing 5H, similarly to the above-described embodiment.

While various embodiments of the present invention and modifications thereof have been described above, it will be understood that features, a combination of the features, and so on according to each of the embodiments and the modifications thereof are only illustrative, and that an addition, elimination, and substitution of a feature(s), and other modifications can be made without departing from the scope and spirit of the present invention. Also note that the present invention is not limited by the embodiment.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a motor having a rotor that rotates about a motor axis and a stator surrounding the rotor;
a housing having a motor accommodating portion that accommodates the motor;
a fluid that accumulates in the housing;
a flow path through which the fluid flows; and
a pump that pressure-feeds the fluid in the flow path,
wherein
the flow path includes:
a pipe-shaped intra-housing flow path disposed inside the motor accommodating portion and provided with a feed hole for feeding the fluid to the motor;
a pipe portion that is disposed inside the motor accommodating portion and relays between the pump and the intra-housing flow path; and
an intra-side wall flow path provided in a wall portion of the housing and connecting the pipe portion and the intra-housing flow path, and
the pipe portion and the intra-housing flow path are connected to each other by a coupling portion.

2. The drive apparatus according to claim 1, wherein the pipe portion, the intra-housing flow path, and the coupling portion are formed of a flow path member that is a single member.

3. The drive apparatus according to claim 2, wherein
the pipe portion and the intra-housing flow path extend in parallel with each other,
the coupling portion extends along a direction in which the pipe portion and the intra-housing flow path extend, and
the coupling portion is provided with a through hole.

4. The drive apparatus according to claim 2, wherein the flow path member includes a rib that reinforces the coupling portion.

5. The drive apparatus according to claim 4, wherein
the flow path member is provided with a recess surrounded by the pipe portion, the intra-housing flow path, the coupling portion, and the rib, and
a through hole is provided in at least one of the coupling portion and the rib.

6. The drive apparatus according to claim 1, wherein
the pipe portion and the intra-housing flow path extend in parallel with each other, and
when viewed from a direction in which the pipe portion and the intra-housing flow path extend,
any one of the pipe portion and the intra-housing flow path is disposed below another.

7. The drive apparatus according to claim 1, comprising:
a transmission mechanism including a plurality of gears and configured to transmit power of the motor,
wherein
the transmission mechanism includes a shaft centered on an axis extending in parallel with the motor axis,
the housing supports the shaft via a bearing,
the intra-housing flow path is provided with a feed hole for feeding the fluid to the bearing, and
the intra-housing flow path is disposed below the pipe portion and above the motor axis and the axis.

8. The drive apparatus according to claim 1, wherein a distance between the intra-housing flow path and the motor axis is shorter than a distance between the pipe portion and the motor axis.

9. The drive apparatus according to claim 1, wherein
the pipe portion and the intra-housing flow path extend in parallel with each other, and
a flow direction of the fluid flowing through the pipe portion and a flow direction of the fluid flowing through the intra-housing flow path are opposite to each other.

10. The drive apparatus according to claim 1, comprising:
a pump that pressure-feeds the fluid in the flow path,
wherein
the housing is provided with a fluid reservoir that stores the fluid, and
the flow path includes:
a flow path connecting the fluid reservoir and the pump; and
a flow path connecting the pump and the pipe portion.
